(19) United States
(12) Patent Application Publication
(10) Pub. No.: US 2002/0021622 A1
(43) Pub. Date: Feb. 21, 2002

(54) Multifunction wristwatch with electronic device and foldable display screen

(76) Inventor: Jean-Michel Baroche, Paris (FR)

Correspondence Address: MERCHANT & GOULD PC, P.O. BOX 2903, MINNEAPOLIS, MN, 55402-0903, US

(21) Appl. No.: 09/832,313

(22) Filed: Apr. 9, 2001

Related U.S. Application Data
(60) Provisional application No. 60/195,619, filed on Apr. 7, 2000.

(51) Int. Cl. G04B 47/00; G04C 19/00

(52) U.S. Cl. 368/10; 368/82

(57) ABSTRACT

A wrist watch includes an electronic wireless communication device that is exposed by shifting a watch part from the body of the wrist watch. A foldable display is mounted on the watch part and is exposed when the watch part is shifted. The foldable display can be unfolded so that the wearer can view video signals on the foldable display.

### CROSS-REFERENCE TO RELATED APPLICATIONS

This application claims the benefit of U.S. Provisional Application No. 60/195,619, filed Apr. 7, 2000, under 35 U.S.C. § 119(e).

### FIELD OF THE INVENTION

The present invention is related to electronic devices worn on a user's wrist, more particularly, to wristwatches with an electronic communication device.

### BACKGROUND INFORMATION

Given the present developments in the electronic industry, miniaturization is becoming more and more complete for devices such as the telephone and the services of links by radio-communication. So there is a trend toward developing multifunction objects that can be carried or worn by people, in particular wristwatches, which supplement their usual function with a supplementary function, using an electronic device.

The difficulty that we run into is then being able to have a usable dial, fitted with keys, the structure of which is such that users have enough space to regularly actuate each key with a finger.

### SUMMARY

The purpose of this invention is to solve the problem of providing a wristwatch with a usable dial, fitted with keys, the structure of which is such that we have enough space to regularly actuate each key with a finger. One aspect of the present invention aims to constitute a multifunctional device, coming in the form of a wristwatch, the part providing the time being able to be shifted to free up the device's body. In particular, this device is characterized by the fact that the device's body, freed up in this way by the shift of the watch, contains, on its periphery, a number of keys that make it possible to easily actuate the electronic device with a finger. This simple device makes it possible to cover and to mask the electronic device's keys when the latter are not being used, the device according the invention then having the general appearance of a wristwatch.

The shift of the part constituting the watch can be a flip which takes place, for example, spontaneously, under the effect of a spring. The freeing of the part constituting the watch being able to be done by any system, for example, a push-button which is located near the watch from the device's body. The spring makes it possible to flip open the device by pivoting the part constituting the watch from the device's body.

In compliance with the invention, thanks to the fact that the electronic control keys are arranged on the periphery of the lower body of the device, space is left at the center of the device to receive, for example, a box with a corresponding dimension. The box itself is fitted with a cover. The box can be used, among other purposes, as a pill box. This central space can also be used to contain an electronic device, including a display screen. When the electronic device according to the invention is a mobile telephone, the central space also contains a miniaturized receiver and microphone.

In this way, with the device according to the invention, the dimensions of which are comparable to those of a conventional wristwatch, we can have, around the lower box, a sufficient number of keys, for example, ten or twelve, which can be easily actuated with the aid of a finger without risking uncertainty about the key actuated in this way. In accordance with this embodiment of the present invention, parts of the electronic device and/or the cell batteries or storage batteries can be installed in or on the strap or bracelet.

In accordance with another embodiment of the present invention, an electronic relay and its power supply can be installed in another location on the user's body, for example, in a pocket or on the belt. This embodiment, while using more energy, provides a more powerful means of wireless communication with the outside world. The electronic relay communicates with a wrist-worn device similar to the wrist-worn device described above. The relay can communicate with the wrist worn device with or without a wire connection to the wrist-worn device. Also, the main energy storage battery can be carried more easily than if it were integrated with the device worn on the wrist.

In yet another aspect of the invention, the display portion of the electronic device includes a foldable display unit having two or more Liquid Crystal Display regions that are joined together by hinges. The multi-part display may show a single image on each of the display regions, a portion of the single image on each display region such that together the several display regions render the entire single image, or a separate image may be shown on each display region. The display regions fold together to be closed up into the watch.

### BRIEF DESCRIPTION OF THE DRAWINGS

FIG. 1 is a perspective view of a first version of the device according to the invention in open position.

FIG. 2 is a perspective view, corresponding to FIG. 1, in closed position.

FIG. 3 is a perspective view of a pill box which might be installed in the central cavity of the body of the device in FIG. 1.

FIG. 4 is a perspective view of a second version of the invention in which the central cavity of the device's body is occupied by an electronic device, containing display zones.

FIG. 5-11 are perspective views of additional embodiments showing foldable displays.

### DETAILED DESCRIPTION

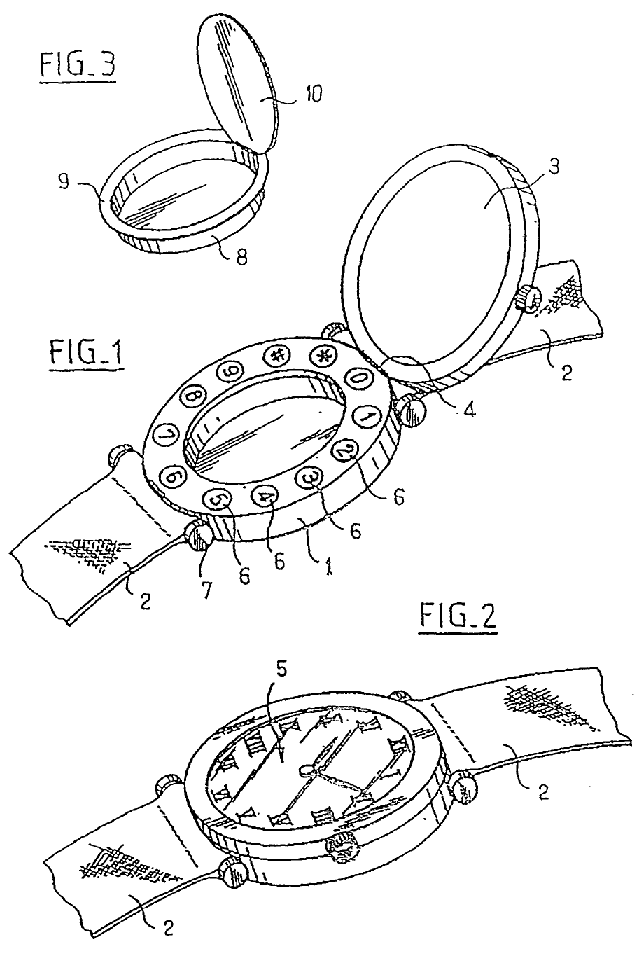

FIG. 1 shows a perspective diagram of a first version of the invention which has a main body 1, fitted at the two extremities with a strap or bracelet 2, which makes it possible to wear the inventive device on the wrist as one does with a wristwatch. A box 3, articulated at hinge 4 on body 1, is fitted with a conventional watch, the dial of which is located on its face opposite the device's body.

On the periphery of the body 1, are located keys 6, numbered in this embodiment as “0” to “9”, along with a double dagger (or pound sign) and a star (or asterisk). The keys 6 are used in the normal manner to operate an electronic device that is contained in the body 1. This electronic device can include, for example, a calculator, a telephone or any other means of radio-communication. In light of the present disclosure, those skilled in the art can adapt a miniature telephone to fit within body 1, with keys 6 arranged along the periphery of body 1. The configuration of the keys 6 allows the user to operate the electronic device that is contained in the body 1 while being worn on the user's wrist. Alternatively, the electronic device may be contained in body 1 and/or partially in the bracelet 2 or in the box 3 that contains the watch. For example, a display may be mounted on box 3 on the side opposite that of the watch.

The box 3, which contains the watch, can advantageously be pushed back into the open position, shown on FIG. 1 in the usual position, by using a spring which is found at hinge 4.

FIG. 2 shows the device in the closed position. In closed position, the box 3 is held against the body 1 by some mechanism, for example, a catch, which can be freed by the action of a finger against the watch's box or by pressing laterally on a bar 7 which connects the body 1 to the strap or bracelet 2.

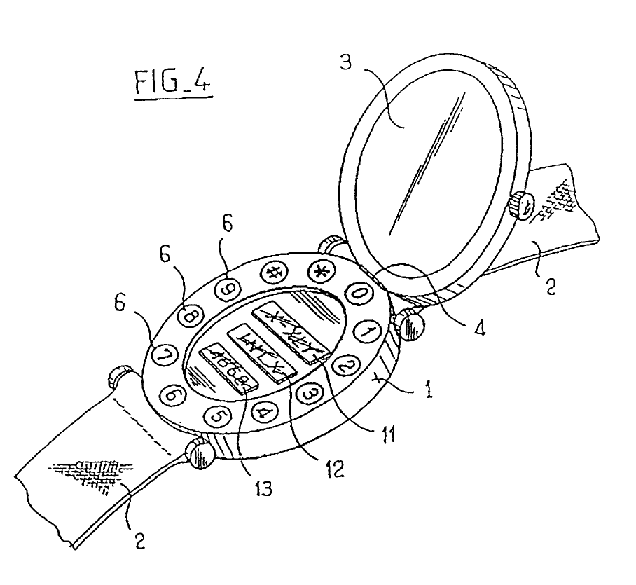

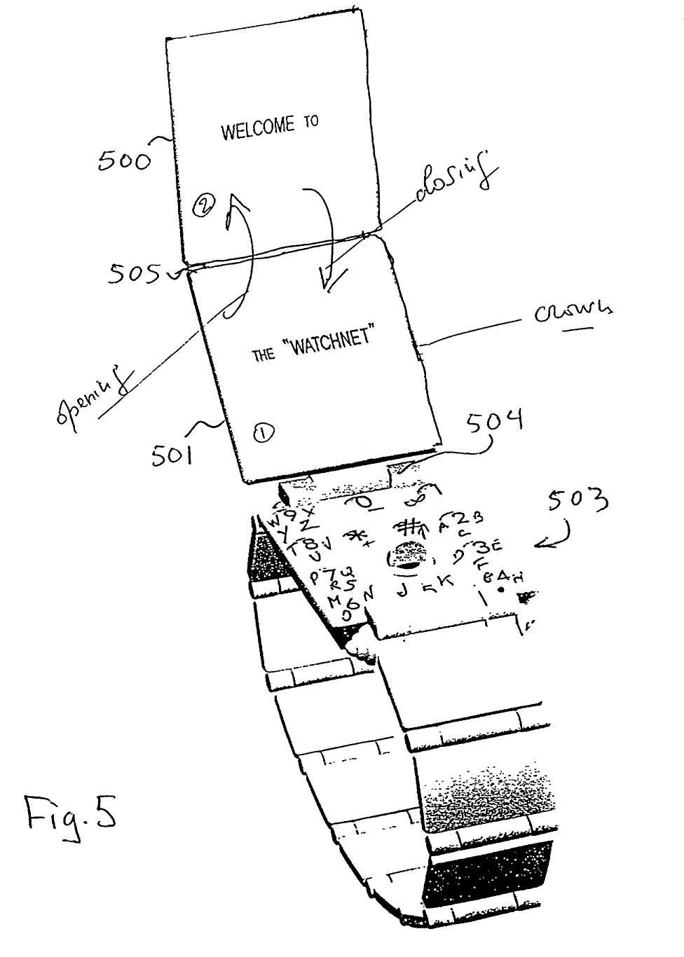

In the version shown on FIG. 1, the central space of body 1 is left free which makes it possible to position there, if so desired, a box of the corresponding shape, as shown on FIG. 3. This box itself includes a body 8, fitted with a flange 9 that bears against the top of body 1, and a cover 10 which protects the box's content when the keys are being used.

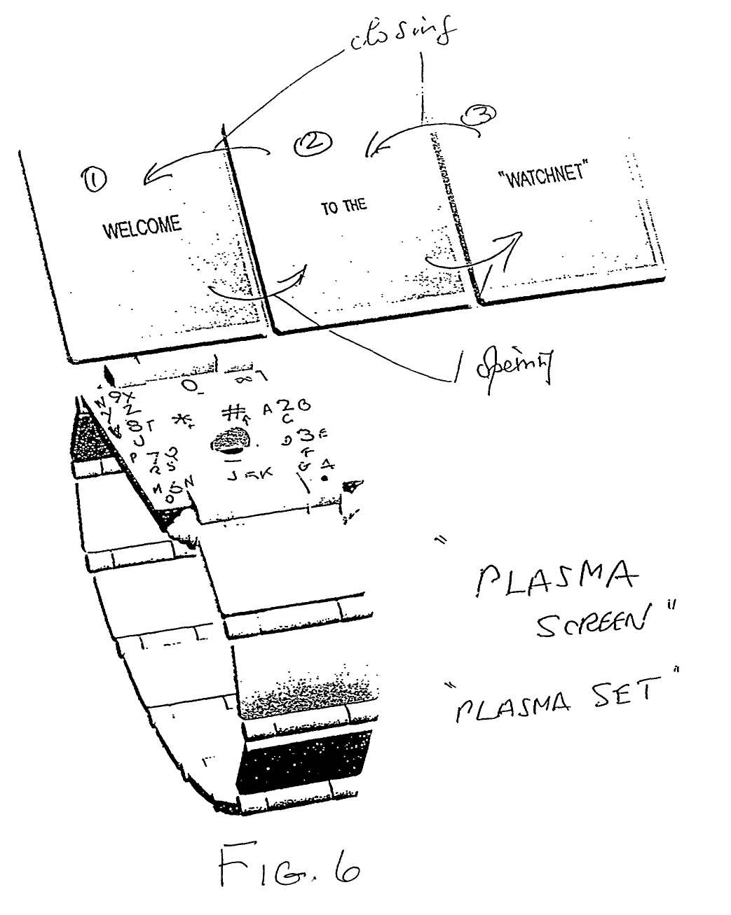

FIG. 4 is a variant of FIGS. 1, 2 and 3 in which the central space of body 1 is occupied by an electronic device, which, in the version described, contains three display zones.

Naturally, the versions that are described above have no particular design limits and they may receive all desirable modifications without, for that purpose, abandoning the framework of the invention.

In accordance with the present invention, a part of the electronic device and/or the cell batteries or storage batteries can be installed in or on the strap or bracelet 2.

In accordance with another embodiment of the invention, an electronic relay unit and its power supply can be installed in another location on the user's body, for example, in a pocket or on a belt to be worn by the user. The relay unit, which drains more energy, provides telecommunication functions with the outside world (i.e., an outside telephone network) and provides a transmission link (with or without a wire connection) to the device according to the invention described above in conjunction with FIGS. 1-4. For example, the electronic device can be a wireless transceiver unit that is configured to communicate with the relay unit, which in turn is used to communicate with a cellular telephone network. The relay unit is equivalent in function to a wireless telephone configured with a remote “handset” (i.e., microphone and speaker) fitted into body 1. For example, the relay unit may be a mobile wireless telephone (i.e., a cell phone) that includes a bluetooth transceiver chip. Body 1 also includes a bluetooth transceiver chip. This embodiment allows the electronic device fitted in body 1 to be smaller and less complex. Another advantage of this embodiment is that the main energy storage batter can also be carried more easily than if it were integrated with the device worn on the wrist.

In another embodiment, the electronic communication device may include a removable earpiece. That is, the earpiece is detachably mounted in the portion of the electronic device disposed in body 1. The detachable earpiece is coupled to the electronic device either through a wire or wirelessly (e.g., using a bluetooth chip).

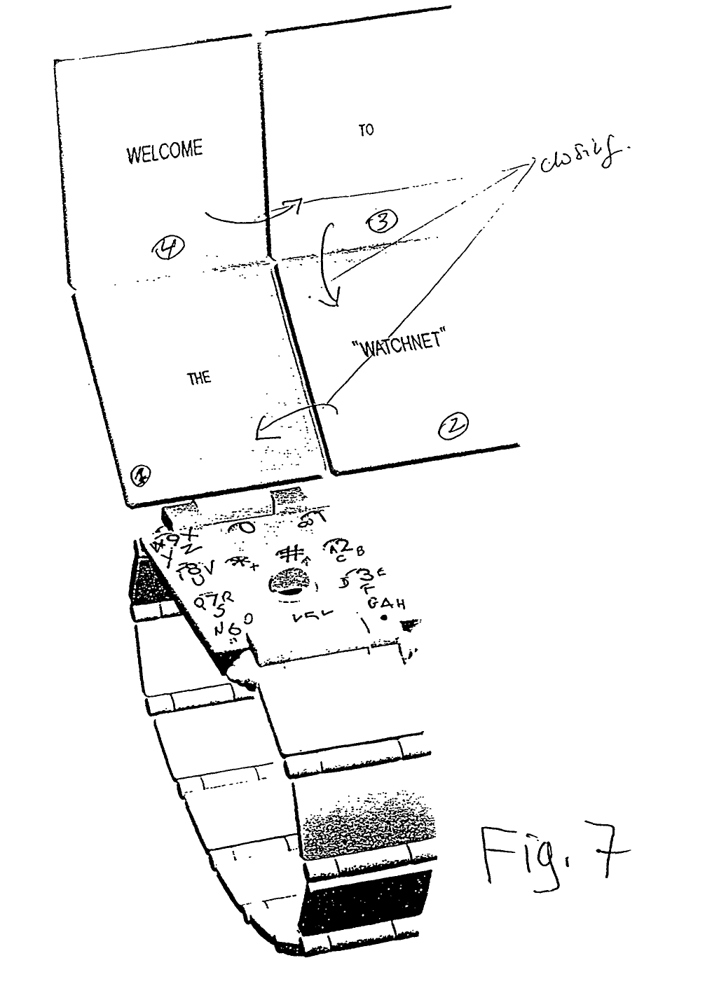

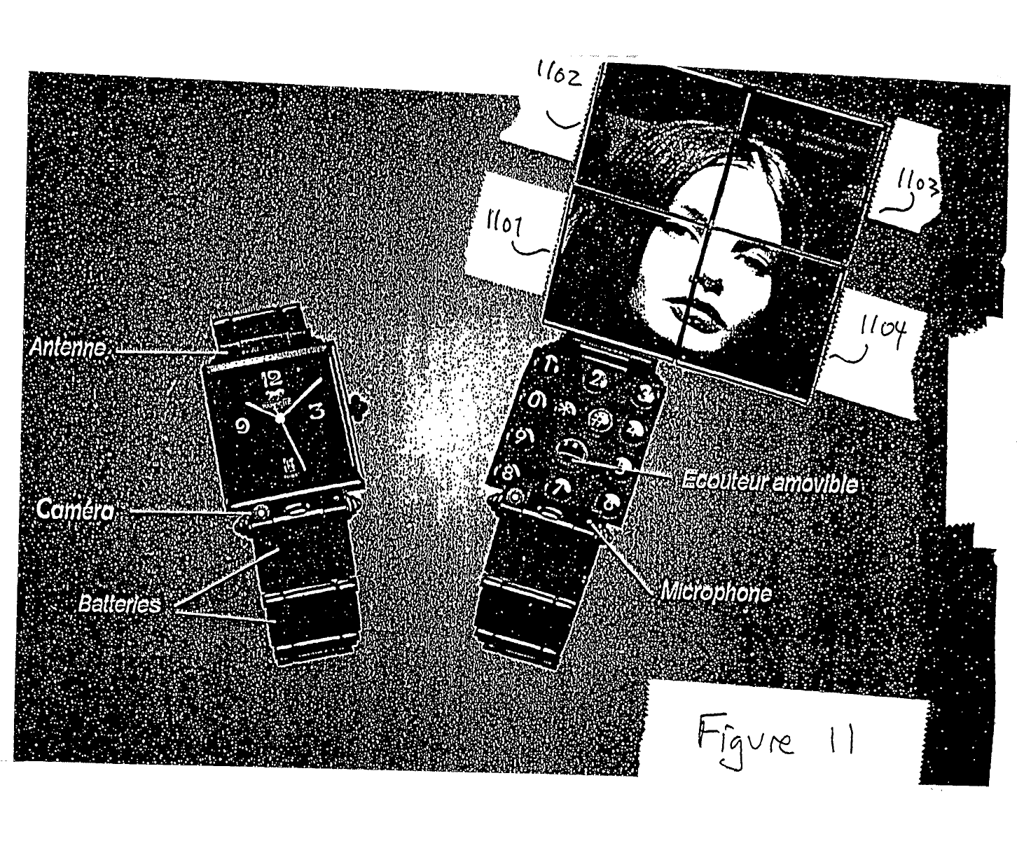

FIGS. 5-11 illustrate various embodiments of the present invention having foldable displays. These embodiments are similar to the embodiment of FIG. 4, with the addition of foldable displays having multiple display regions. Each display region could be a separate liquid crystal display (LCD) device electrically interconnected to a common display generation mechanism. The display regions become visible to the user when each display region is unfolded. In these embodiments, the electronic device includes circuitry to operate the displays. In one embodiment, the electronic circuitry provides signals that are displayed on the foldable display as a single image (e.g., a portion of the entire image is displayed on each of the multiple display regions, rather than the entire image being displayed on every region). Alternatively, the entire image could be displayed on each display region. For example, the electronic device could be a video telephone transceiver device capable of generating both audio and video signals, which are respectively provided to a speaker and the foldable display so that the user can listen to and view the video telephone message.

In the first embodiment, a single LCD is attached to the underside of the watch part. Thus, when the user opens the wristwatch, the display becomes visible. Such LCDs are currently available. In one embodiment, opening the wristwatch also turns on the LCD. Turning to FIG. 5, a multi-part LCD device is shown having two display regions—an upper region 500 and a lower region 501. The multiple-display embodiments use multiple LCD displays that are attached to the watch part by hinges. Opening the LCD device illustrated in FIG. 5 occurs by swinging the lower region 501 (from the closed position) away from the body 503 of the watch about a hinge 504 connecting the LCD device to the body 503. Then the upper region 500 may be swung away from the lower region 501 about a second hinge 505. The display portions of the upper region 500 and the lower region 501 may be electrically connected using a flexible connector, such as a ribbon cable or the like, disposed within the hinges (e.g., first hinge 504 and second hinge 505).

At that point, a display image may be may be rendered on the LCD device, either as a single image displayed on each of both portions of the LCD device, or as an image that is broken into two parts, one part being displayed on the upper region 500 and the other part being displayed on the lower region 501. Likewise, two different images may be displayed on each of the display portions. For example, if two telephonic conversations were being held simultaneously, the LCD device could be used to display a video image associated with one of the telephonic conversations on the upper region 500 and a video image associated with the other telephonic conversation on the lower region 501.

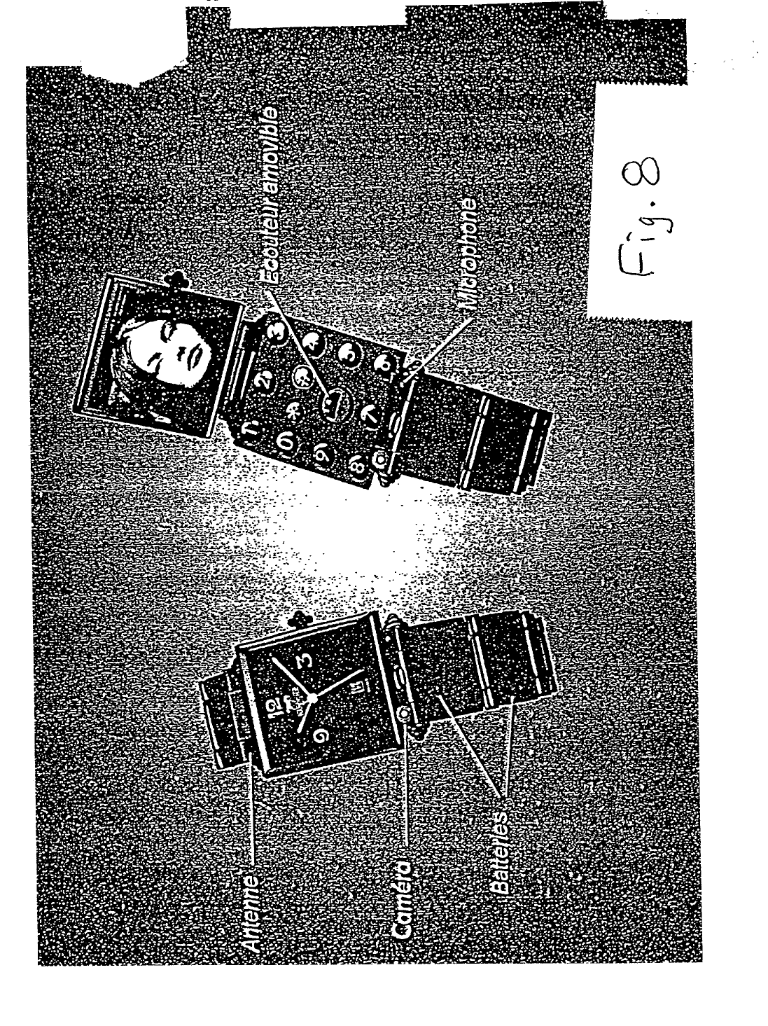

FIG. 6 illustrates an alternative embodiment of the invention having a 3-part LCD device which opens horizontally to present 3 display regions, each being a plasma screen, which cooperate to function as a “plasma set.” FIG. 7 illustrates another alternative embodiment of the invention having a 4-part video display. Wiring to transmit the power and video signals from the electronic device can be run through the hinges and connected to each LCD. Batteries for powering the electronic device and the video displays can be formed in the bracelet. In particular, flexible batteries can be used in the bracelet.

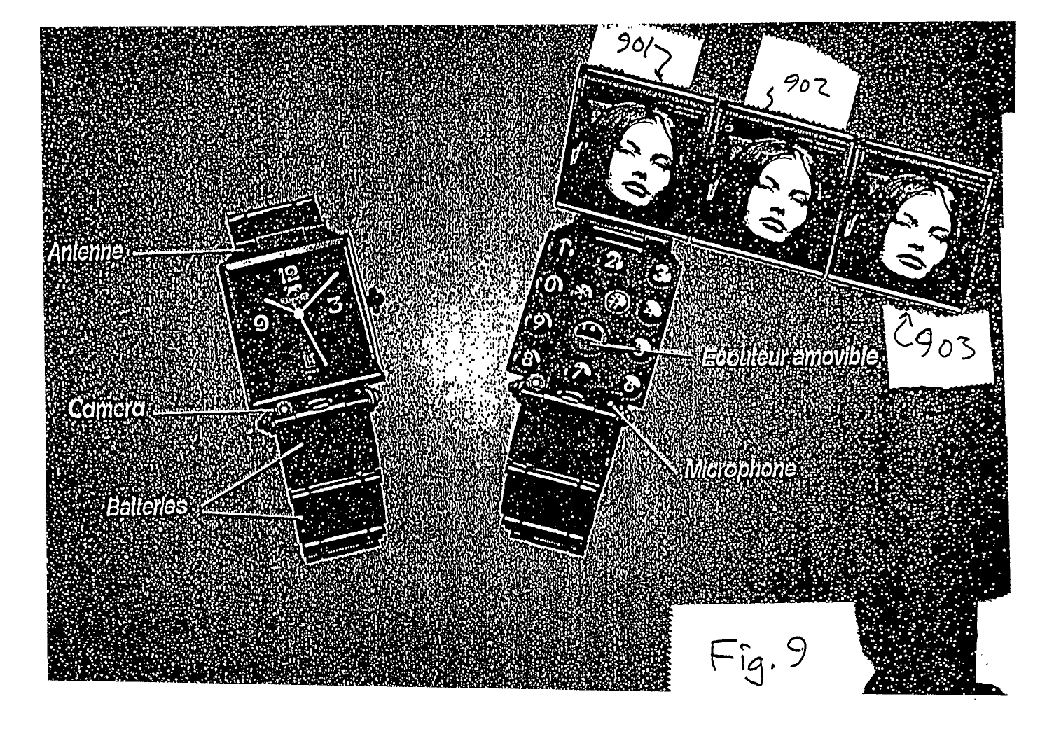

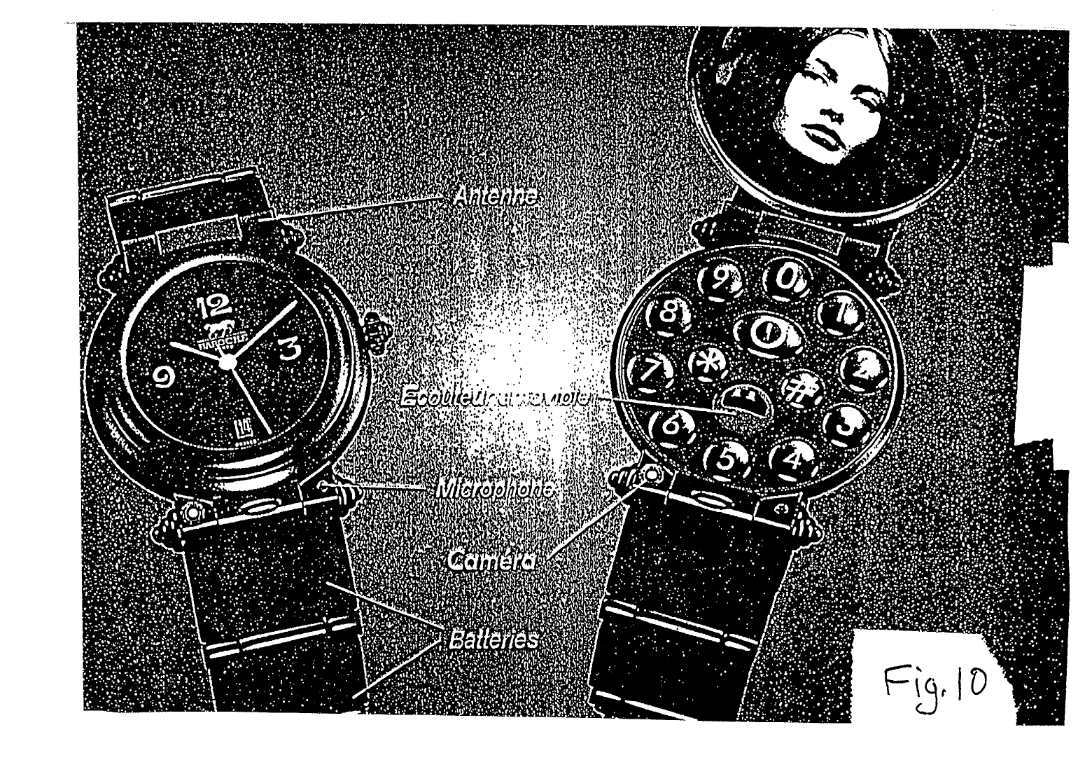

FIGS. 8-11 illustrate several actual embodiments of the invention having folding display screens of various configurations. For example, FIG. 9 illustrates one embodiment of the invention having a three-part LCD device, with a single image reproduced on each of the three display regions 901, 902, 903. Alternatively, FIG. 11 illustrates another embodiment of the invention having a four-part LCD device, with a portion of a single image being displayed on each of the four display regions (1101, 1102, 1103, 1104) to form one larger single image.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

I claim:

1. A wristwatch, comprising:
a body having a central portion and a periphery;
a plurality of keys located on the periphery of the body;
an electronic wireless communication device disposed in a central space of the body configured to be operated by the plurality of keys;
a watch part coupled to the body, wherein the watch part is configured to be shiftable from the body to expose the electronic wireless communication device; and
a foldable display mounted on the watch part and electrically coupled to the electronic wireless communication device, wherein the display is covered by the watch part when the watch part is not shifted and is exposed when the watch part is shifted, and wherein the foldable display has a plurality of regions, the regions being visible to a wearer when the foldable display is unfolded.

2. The wristwatch of claim 1 wherein each region of the plurality of regions comprises a liquid crystal display device.

3. The wristwatch of claim 1 wherein the wireless communication device is configured to display video signals using the foldable display.

4. The wristwatch of claim 1, wherein the foldable display comprises two display regions joined by a hinge, the hinge including electrical circuitry sufficient to pass an electrical signal from one display region to the other display region, one of the two display regions being joined to the body by another hinge.

5. The wristwatch of claim 1, wherein the foldable display comprises three display regions.

6. The wristwatch of claim 5, wherein the three display regions are arranged to fold out into a three-piece horizontally-viewed display area.

7. The wristwatch of claim 1, wherein the foldable display comprises four display regions.

8. The wristwatch of claim 7, wherein the four display regions are arranged to fold out into a single display area two display regions wide by two-display regions tall.

9. A wristwatch, comprising:
a body having a central portion;
an electronic wireless communication device coupled to the body;
a multi-part Liquid Crystal Display (LCD) device including a plurality of display regions, each display region being connected to at least one other display region in the plurality of display regions by a hinge, each display region being configured to provide a display based on a display signal provided by the electronic wireless communication device.

10. The wristwatch of claim 9, wherein the LCD device is further configured to present a single image rendered similarly on each display region in the plurality of display regions.

11. The wristwatch of claim 9, wherein the LCD device is further configured to render a separate portion of a single image on each display region in the plurality of display regions such that when viewed together, the separate portions form the entire single image.

12. The wristwatch of claim 9, wherein the plurality of display regions comprises two display regions joined by a hinge, the hinge including electrical circuitry sufficient to pass an electrical signal from one display region to the other display region, one of the two display regions being joined to the body by another hinge.

13. The wristwatch of claim 9, wherein the plurality of display regions comprises three display regions.

14. The wristwatch of claim 13, wherein the three display regions are arranged to fold out into a three-piece horizontally-viewed display area.

15. The wristwatch of claim 9, wherein the plurality of display regions comprises four display regions.

16. The wristwatch of claim 15, wherein the four display regions are arranged to fold out into a single display area two display regions wide by two-display regions tall.
